(19) United States
(12) Patent Application Publication
(10) Pub. No.: US 2023/0409977 A1
(43) Pub. Date: Dec. 21, 2023

(54) COMPUTER-READABLE RECORDING MEDIUM STORING SETTING PROGRAM, METHOD OF SETTING, AND INFORMATION PROCESSING APPARATUS

(71) Applicant: Fujitsu Limited, Kawasaki-shi (JP)

(72) Inventor: Yusuke HAMADA, Ota (JP)

(73) Assignee: Fujitsu Limited, Kawasaki-shi (JP)

(21) Appl. No.: 18/307,884

(22) Filed: Apr. 27, 2023

(30) Foreign Application Priority Data
Jun. 17, 2022 (JP) 2022-098283

(51) Int. Cl. G06N 20/00

(52) U.S. Cl. CPC G06N 20/00

(57) ABSTRACT

A non-transitory computer-readable recording medium stores a setting program for causing a computer to execute a process including: accepting designation of a first setting value for an entirety of a plurality of hyperparameters included in a machine learning model and designation of one or more second setting values that respectively indicate differences with respect to the first setting value; and causing a plurality of hyperparameter groups generated based on the first setting value that has been designated and the second setting values that have been designated to be set in the machine learning model.

### CROSS-REFERENCE TO RELATED APPLICATION

This application is based upon and claims the benefit of priority of the prior Japanese Patent Application No. 2022-98283, filed on Jun. 17, 2022, the entire contents of which are incorporated herein by reference.

### FIELD

The embodiment discussed herein is related to a computer-readable recording medium storing a setting program, a method of setting, and an information processing apparatus.

### BACKGROUND

Today, machine learning is actively used in a wide variety of fields including manufacturing and medical fields. In machine learning, for example, a machine learning model is trained on a predetermined task by using learning data. Examples of the predetermined task include time-series prediction, image classification, speech recognition, and so forth. For example, examples of the predetermined task include determination of a defect of an article manufactured based on an image, determination of a health condition of an employee based on attendance record data of the employee, and so forth. When the training has been completed, unknown data related to the predetermined task is input to the trained machine learning model to obtain an estimation result. The estimation result is used to evaluate estimation accuracy of the machine learning model used for the estimation. As an example of the machine learning, deep learning using a neural network (NN) as a learning model is known.

Japanese Laid-open Patent Publication No. 2018-156473 is disclosed as related art.

### SUMMARY

According to an aspect of the embodiments, a non-transitory computer-readable recording medium stores a setting program for causing a computer to execute a process including: accepting designation of a first setting value for an entirety of a plurality of hyperparameters included in a machine learning model and designation of one or more second setting values that respectively indicate differences with respect to the first setting value; and causing a plurality of hyperparameter groups generated based on the first setting value that has been designated and the second setting values that have been designated to be set in the machine learning model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an information processing apparatus according to an embodiment;

FIG. 2 is a diagram illustrating an example of a GUI for selecting parameters;

FIG. 3 is a diagram illustrating an example of tried hyperparameter information;

FIG. 4 is a flowchart relating to generation and use of hyperparameters according to the embodiment; and

FIG. 5 is a hardware configuration diagram of the information processing apparatus.

### DESCRIPTION OF EMBODIMENTS

In such machine learning, when the machine learning model is trained, an operation of selecting an optimum parameter is performed by performing a trial with various hyperparameters. Usual techniques for causing a training tool to read the hyperparameters include the following three techniques.

One of the three is a method in which a user describes the hyperparameters directly in code. Another is a method in which the hyperparameters are read from an external file such as a database. The remaining one is a method in which the hyperparameters are automatically generated by an optimization tool.

A technique of determining preferable improvement parameters as the hyperparameters has been proposed so that efficient optimization may be performed even by a designer with little design knowledge. For example, a technique has been proposed in which improvement parameters preferable as parameters of an activation function of a machine learning model are determined with proven information as teacher data and the improvement parameters are determined again by using an evaluation value of output from the machine learning model using the improvement parameters.

However, in many cases there are tens to hundreds of the hyperparameters, and also in many cases there are dependency relationships between the parameters. In a case where the hyperparameters are read from the external file, when the hyperparameters are simply defined as the external file on a training trial-by-training trial bases, the external file in which all the parameters are defined is created every time a new trial is performed, and accordingly, management becomes complicated.

The technique of determining the improvement parameters by using the proven information as the teacher data is the method of automatically generating the hyperparameters, and applying this technique to the technique of defining the hyperparameters as the external file is difficult.

The disclosed technique has been made in view of the above description and aims to provide a setting program, a method of setting, and an information processing apparatus that reduce complexity of management of hyperparameters in training.

An embodiment of a setting program, a method of setting, and an information processing apparatus disclosed herein is described in detail with reference to the drawings. The following embodiment is not intended to limit the setting program, the method of setting, or the information processing apparatus disclosed herein.

### EMBODIMENT

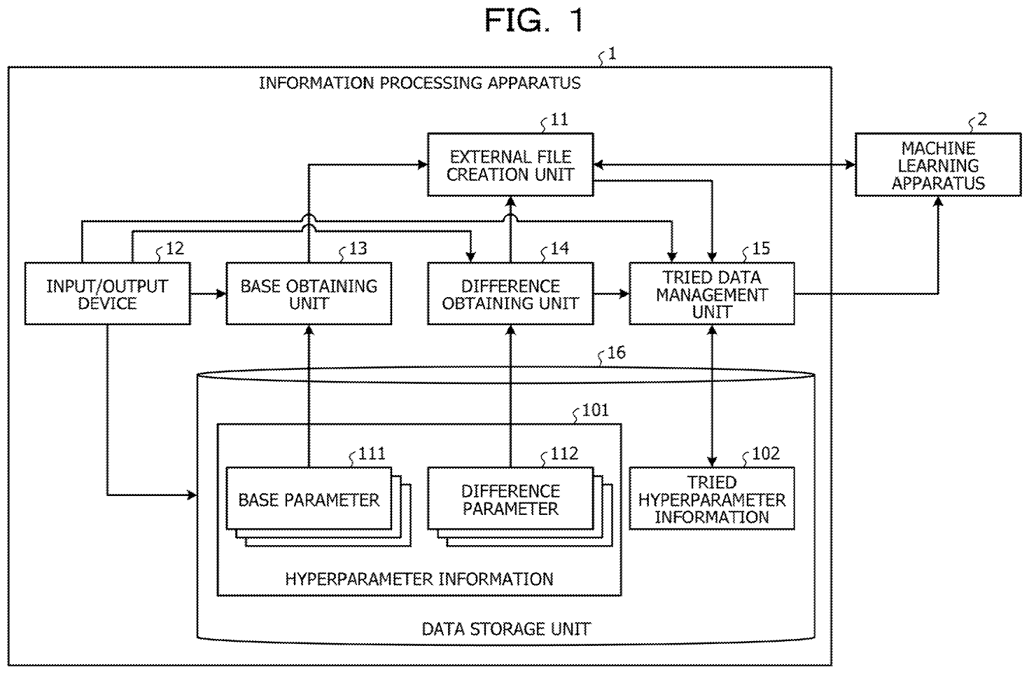

FIG. 1 is a block diagram of an information processing apparatus according to an embodiment. An information processing apparatus 1 generates an external file in which hyperpara meters to be used for the training of a machine learning model are registered and outputs the generated external file to a machine learning apparatus 2. As illustrated in FIG. 1, the information processing apparatus 1 includes an external file creation unit 11, an input/output device 12, a base obtaining unit 13, a difference obtaining unit 14, a tried data management unit 15, and a data storage unit 16.

The data storage unit 16 stores hyperparameter information 101 and tried hyperparameter information 102. One or a plurality of base parameters 111 and a plurality of difference parameters 112 are included in the hyperparameter information 101. The hyperparameter information 101 is created by a developer who trains the machine learning model and stored in the data storage unit 16 by using the input/output device 12 or the like. Hereinafter, the developer who trains the machine learning model is simply referred to as a “user”.

A plurality of the hyperpara meters are included in the machine learning model. Hereinafter, the plurality of hyperparameters included in the machine learning model are collectively referred to as a “hyperparameter group”. For example, in a case where the machine learning model is trained, values of all the hyperparameters included in the hyperparameter group are set in a single trial of the training.

A base parameter 111 is a set of setting values of the hyperparameter including setting values of all hyperparameters included in the basic hyperparameter groups each of which is used for the single trial of the training of the machine learning model. Preferably, the setting values of the hyperparameters included in the base parameter 111 are values selected to efficiently proceed the training of the machine learning model.

The base parameters 111 have respective parameter names. For example, preferably, the base parameters 111 each have a corresponding one of the parameter names which represents the feature thereof, for example, with which the intention for which the base parameter 111 is provided is presumable. The base parameter 111 is an example of a “first setting value”.

A difference parameter 112 is information on the setting values each of which is a difference of the base parameters 111. The difference parameter 112 includes differences of some of the hyperparameters of the setting values of the plurality of hyperparameters included in the base parameter 111.

In the difference parameter 112, a plurality of groups of differences of different portions in the base parameter 111 may be set. For example, the difference parameters 112 that are differences of the same hyperparameter may be grouped and classified.

The difference parameters 112 also have respective parameter names. For example, preferably, each of the difference parameters 112 also have a corresponding one of the parameter names which represents the feature thereof, for example, with which the intention for which the difference parameter 112 is provided is presumable. The difference parameter 112 is an example of a “second setting value”.

The tried hyperparameter information 102 is information indicating the hyperparameters used in a trial of the training of the machine learning model. The tried hyperparameter information 102 is generated by the tried data management unit 15.

The input/output device 12 includes a display device such as a monitor and input devices such as a keyboard and a mouse. The user selects the base parameter 111 and the difference parameter 112 by using the input/output device 12 and inputs information on the selected base parameter 111 and the difference parameter 112 to the information processing apparatus 1.

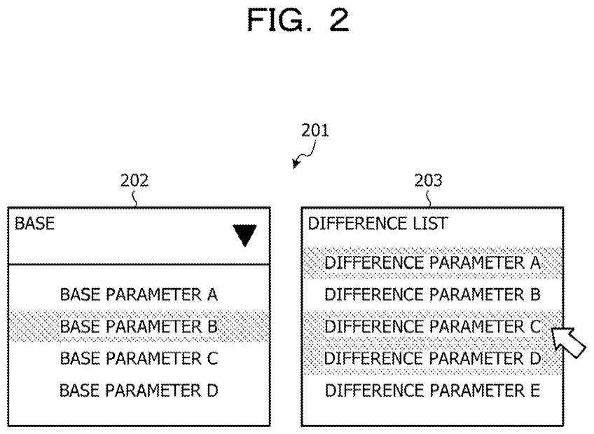

For example, the input/output device 12 allows the user to select and input the base parameter 111 and the difference parameter 112 by using a graphical user interface (GUI). FIG. 2 is a diagram illustrating an example of a GUI for selecting parameters. The input/output device 12 causes the display device included therein to display a GUI 201 illustrated in FIG. 2. A parameter selection screen 201 includes a base parameter selection region 202 and a difference parameter selection region 203. The base parameter selection region 202 displays the base parameters 111 by using a drop-down list. The difference parameter selection region 203 displays the difference parameters 112 by using a list box.

When the user presses down a drop-down button with a mouse or the like, the input/output device 12 displays a list of the base parameters 111 in the base parameter selection region 202. The input/output device 12 accepts selection of one or more base parameters 111 to be used for training of the machine learning model from among a plurality of the base parameters 111 displayed in the base parameter selection region 202.

The input/output device 12 accepts selection of one or more difference parameters 112 from among a list of a plurality of the difference parameters 112 displayed in the difference parameter selection region 203. However, in a case where no difference parameter 112 is selected, the machine learning model is trained by using the base parameter 111. For example, in a case where the difference parameters 112 are divided into groups based on the types of the hyperpara meters, the user may select one or a plurality of the difference parameters 112 on a group-by-group basis from some of the groups. Thus, the information processing apparatus 1 may use a combination of different types of difference parameters 112 as the differences of the base parameters 111.

After that, when the selection of the base parameters 111 and the difference parameters 112 is confirmed by the user, the input/output device 12 outputs to the base obtaining unit 13 information on the base parameters 111 selected in the parameter selection screen 201. The input/output device 12 also outputs to the difference obtaining unit 14 information on the difference parameters 112 selected in the parameter selection screen 201.

Alternatively, the user may designate the base parameter 111 and the difference parameter 112 by using a command line interface (CLI). For example, the input/output device 12 receives input of the parameter name of the base parameter 111 and the parameter name of the difference parameter 112. The input/output device 12 may use a file name or a database record name as a file name. For example, the input/output device 12 receives an input of syntax such as “$ train -b base_param2 -d diff_param1 diff_param3” via the CLI. Also in this case, the input/output device 12 may receive a plurality of designations of both the base parameters 111 and the difference parameters 112. The input/output device 12 identifies, from the input data, the parameter names of the base parameters 111 and the difference parameters 112. The input/output device 12 outputs to the base obtaining unit 13 information on the identified base parameters 111. The input/output device 12 outputs to the difference obtaining unit 14 information on the identified difference parameters 112.

The base obtaining unit 13 receives from the input/output device 12 input of the information on the base parameters 111 selected by the user. The base obtaining unit 13 obtains the designated base parameters 111 from the data storage unit 16. After that, the base obtaining unit 13 outputs the obtained base parameters 111 to the external file creation unit 11. The base obtaining unit 13 is an example of a “first obtaining unit”.

The difference obtaining unit 14 receives from the input/output device 12 input of the information on the difference parameters 112 selected by the user. For example, in a case where the difference parameters 112 are divided into groups based on the types of the hyperparameters, the difference obtaining unit 14 may receive from the input/output device 12 input of the information on the difference parameters 112 on the group-by-group basis. For example, in a case where a plurality of groups of differences of different portions in the first setting values regarding the second setting values are set, the difference obtaining unit 14 receives one or more second setting values in each of the two or more groups.

The difference obtaining unit 14 obtains the designated difference parameters 112 from the data storage unit 16. After that, the base obtaining unit 13 outputs the obtained difference parameters 112 to the external file creation unit 11. The difference obtaining unit 14 is an example of a “second obtaining unit”.

The external file creation unit 11 receives input of the base parameters 111 from the base obtaining unit 13. The external file creation unit 11 also receives input of the difference parameters 112 from the difference obtaining unit 14. Next, the external file creation unit 11 combines the base parameters 111 and the difference parameters 112 with each other to create the plurality of hyperparameter groups to be used for the training. For example, the external file creation unit 11 generates the plurality of hyperparameter groups by adding the differences indicated by the second setting values to the first setting values.

For example, in the case where the difference parameters 112 are divided into the groups based on the types of the hyperparameters, the external file creation unit 11 may receive from the difference obtaining unit 14 input of the difference parameters 112 of some difference parameters 112. In this case, the external file creation unit 11 may create the hyperparameter groups by giving the differences obtained by combining the difference parameters 112 of the groups to the base parameters 111. For example, in the case where the plurality of groups of the differences of the different portions in the first setting values regarding the second setting values are set, the external file creation unit 11 generates the plurality of hyperparameter groups by adding the differences indicated by the second setting values to the first setting values individually on a group-by-group basis.

For example, it is assumed that five types of base parameters 111 are selected. It is also assumed that, among the difference parameters 112 divided into groups based on the types of the included hyperparameters, three types of difference parameters 112 are selected from one group and five types of difference parameters 112 are selected from another group. In this case, the external file creation unit 11 generates 120 (5×4×6) types of the hyperparameter groups including a case where the base parameters 111 themselves are set in the hyperparameter groups used for training without using the difference parameters 112. The external file creation unit 11 creates the external file in which the generated 120 types of hyperparameters are registered. In so doing, the external file creation unit 11 assigns a parameter name to each of the hyperparameter groups.

Next, upon reception of a request for transmission of the external file from the machine learning apparatus 2 for executing training of the machine learning model, the external file creation unit 11 transmits the created external file to the machine learning apparatus 2. Thus, the external file creation unit 11 causes the setting values of each hyperparameter group registered in the external file to be set in the machine learning model. For example, the external file creation unit 11 generates a plurality of the hyperparameter groups based on the designated first and second setting values and causes each of the generated hyperparameter groups to be set in the machine learning model.

After that, the external file creation unit 11 receives from the machine learning apparatus 2 a notification of completion of the training of the machine learning model using the transmitted external file. The external file creation unit 11 sets the hyperparameter groups registered in the transmitted external file as tried hyperparameters and notifies the tried data management unit 15 of information on the tried hyperparameters. For example, the external file creation unit 11 may notify the information on the tried hyperparameters by transmitting the transmitted external file to the tried data management unit 15.

The tried data management unit 15 receives from the external file creation unit 11 input of the information on the tried hyperparameters. For each trial, the tried data management unit 15 registers the tried hyperparameters in a database included in the data storage unit 16. The tried data management unit stores in the data storage unit 16 the tried hyperparameter information 102 in which the base parameters 111 and the difference parameters 112 used to generate the hyperparameter groups which are the tried hyperparameters are registered.

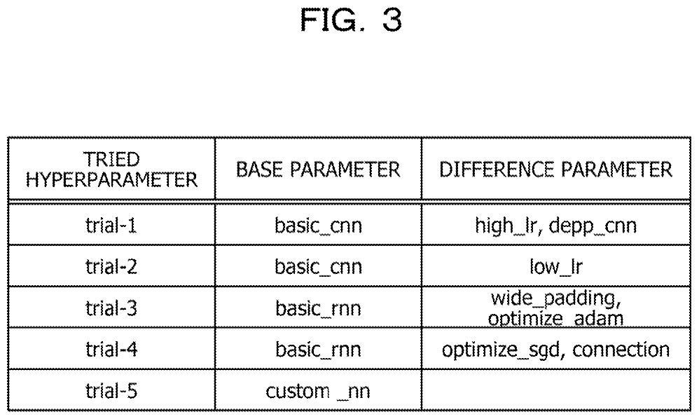

FIG. 3 is a diagram illustrating an example of the tried hyperparameter information. The tried data management unit 15 registers, for example, the parameter names of the tried hyperparameter in the tried hyperparameter information 102. The tried data management unit 15 stores in the tried hyperparameter information 102 the parameter names of the base parameters 111 and the difference parameters 112 used to generate the tried hyperparameters. For example, the tried data management unit 15 registers the base parameter 111 named “basic_cnn” and the difference parameters 112 named “high_Ir” and “deep_cnn” for the tried hyperparameter named “trial-1”.

After that, the tried data management unit 15 receives from the machine learning apparatus 2 a request for transmission of the hyperparameter groups used in the specific trial in order to reproduce the specific trial. The tried data management unit 15 obtains from the database included in the data storage unit 16 the tried hyperparameters in accordance with the request. The tried data management unit 15 transmits the obtained tried hyperparameters to the machine learning apparatus 2 and causes the tried hyperparameters to be set in the machine learning model. Thus, the machine learning apparatus 2 may easily reproduce the trial that has already been performed by using the tried hyperparameters.

For example, in a case where a machine learning process is tried by using the hyperparameter groups set in the machine learning model, the tried data management unit 15 stores in the data storage unit 16 the tried hyperparameter groups used in the trial. Upon reception of the designation of the tried hyperparameter groups, the tried data management unit 15 obtains the tried hyperparameter groups from the data storage unit 16 and causes the obtained tried hyperparameter groups to be set in the machine learning model.

The tried data management unit 15 receives input of a request for displaying of information on the tried hyperpara meters from the user via the input/output device 12. In this case, the tried data management unit 15 obtains the tried hyperparameter information 102 from the data storage unit 16 and outputs the tried hyperparameter information 102 to the input/output device 12 to display the tried hyperparameter information 102 in the display device. From the parameter names of the base parameters 111 and the difference parameters 112 displayed in the tried hyperparameter information 102, the user may check the combinations of the base parameters 111 and the difference parameters 112 that are the sources of the hyperpara meter groups used for the trial.

For example, in the case where the machine learning process is tried by using the hyperparameter groups set in the machine learning model, the tried data management unit 15 stores the tried hyperparameter information 102 in the data storage unit 16. Information on the first setting values and the second setting values used to generate the tried hyperparameter groups used for the trial is registered in the tried hyperparameter information 102. Upon reception of a request for displaying of the tried hyperparameter information 102, the tried data management unit 15 obtains the tried hyperparameter information 102 from the data storage unit 16 and causes the obtained tried hyperparameter information 102 to be displayed in the input/output device 12.

The tried data management unit 15 receives input of a request for displaying of database logs from the user via the input/output device 12. The tried data management unit 15 outputs to the input/output device 12 the database logs of the database in which the tried hyperparameters are registered on a trial-by-trial basis to display the database logs in the display device. When referring to the database logs, the user may determine which hyperparameter group is used in which trial. When using this information and the tried hyperparameter information 102, the user may easily check from which base parameters 111 and difference parameters 112 the hyperparameter groups used in a specific trial are generated.

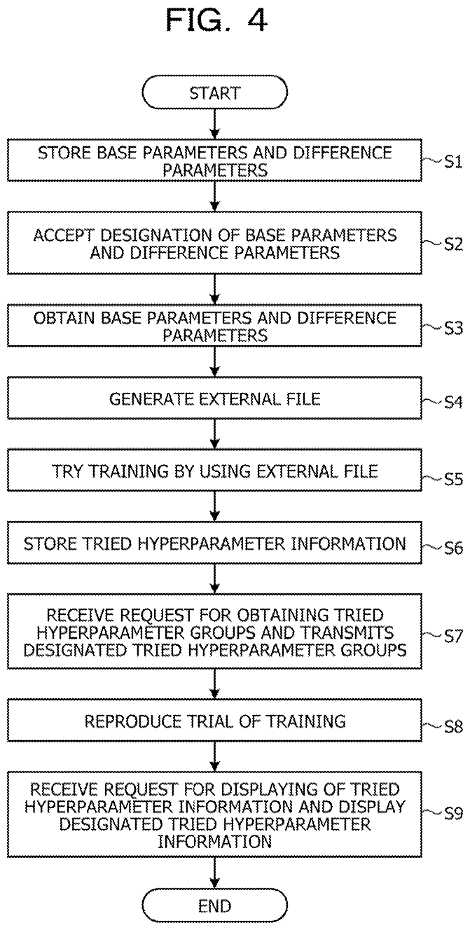

FIG. 4 is a flowchart relating to the generation and use of hyperparameters according to the embodiment. Next, a flow of a hyperparameter generation process and operation in using the hyperparameters by the information processing apparatus 1 according to the embodiment is described with reference to FIG. 4.

The data storage unit 16 stores the hyperpara meter information 101 including the base parameters 111 and the difference parameters 112 created by, for example, the user (step S1).

The input/output device 12 accepts designation of the base parameters 111 and the difference parameters 112 to be used for the training of the machine learning model (step S2).

The input/output device 12 outputs to the base obtaining unit 13 the information on the designated base parameters 111. The input/output device 12 outputs to the difference obtaining unit 14 the information on the designated difference parameters 112. The base obtaining unit 13 obtains from the data storage unit 16 the base parameters 111 designated by the obtained information. The difference obtaining unit 14 obtains from the data storage unit 16 the difference parameters 112 designated by the obtained information (step S3).

The base obtaining unit 13 outputs the obtained base parameters 111 to the external file creation unit 11. The difference obtaining unit 14 outputs the obtained difference parameters 112 to the external file creation unit 11. The external file creation unit 11 combines the obtained base parameters 111 and difference parameters 112 with each other to generate the plurality of hyperparameter groups and generates the external file in which the plurality of generated hyperpara meter groups are registered (step S4).

After that, the external file creation unit 11 receives a request for obtaining the external file, transmits the generated external file to the machine learning apparatus 2, and causes the setting values of the hyperparameter groups registered in the external file to be set in the machine learning model. The machine learning apparatus 2 sequentially sets the setting values of the hyperparameter groups registered in the obtained external file in the machine learning model and repeats the trial of the training (step S5).

When the training using the external file has been completed, the machine learning apparatus 2 notifies the external file creation unit 11 of the completion of the trial using the received external file. The external file creation unit 11 outputs the information on the tried hyperparameters to the tried data management unit 15. The tried data management unit 15 stores in the data storage unit 16 the tried hyperparameter information 102 in which the information on the tried hyperparameters is registered (step S6). For each trial, the tried data management unit 15 registers the tried hyperparameters in the database included in the data storage unit 16.

The tried data management unit 15 receives a request for obtaining the tried hyperparameters from the machine learning apparatus 2. The tried data management unit 15 obtains the designated tried hyperparameters from the database included in the data storage unit 16. The tried data management unit 15 transmits the obtained tried hyperparameters to the machine learning apparatus 2 (step S7).

The machine learning apparatus 2 receives from the tried data management unit 15 the tried hyperparameters designated in the request for obtaining. The machine learning apparatus 2 reproduces the trial of the training of the machine learning model by using the setting values of the received tried hyperparameters (step S8).

The tried data management unit 15 accepts the request for the displaying of the tried hyperparameter information 102 via the input/output device 12. The tried data management unit 15 obtains the tried hyperparameter information 102 from the data storage unit 16. After that, the tried data management unit 15 transmits the tried hyperparameter information 102 to the input/output device 12 and causes the tried hyperparameter information 102 to be displayed in the display device (step S9).

As has been described, the information processing apparatus according to the present embodiment generates the hyperparameter groups to be used in the training of the machine learning model by combining designated base parameters and the designated difference parameters. The information processing apparatus transmits the external file in which the plurality of generated hyperpara meters are registered to the machine learning apparatus and causes the machine learning apparatus to set in the machine learning model. Thus, when the hyperparameter groups are generated by the combinations of the base parameters and the difference parameters, the amount of data to be originally prepared may be suppressed. Accordingly, complexity of management of the hyperparameters in the training may be reduced.

As an example, a case is described in which hyperparameter groups are generated by using five types of base parameters, three types of difference parameters, and five types of difference parameters. Here, the three types of difference parameters and five types of difference parameters are respectively from two groups including different hyperparameters. In this case, when five base parameters and eight types of difference parameters are created, the information processing apparatus 1 according to the present embodiment may generate an external file including 120 (5×4×6) types of hyperparameter groups. In contrast, in a case where the hyperparameter groups are registered one by one to generate the external file, all of 120 types of hyperparameter groups to be tried are created. Thus, when the information processing apparatus according to the present embodiment is used, a developer who trains the machine learning model does not necessarily take on the task of creating the hyperparameter groups individually for all trials, and accordingly, many trials may be performed with a small number of steps. Even in a case where the hyperparameter groups are changed from one trial to the other, not all the hyperparameter groups are necessarily changed for each trial, and accordingly, the machine learning model may be efficiently trained.

When the database logs or the tried hyperparameter information is referred to, the base parameters and the difference parameters used for the trial result may be easily identified. Thus, complexity of management of the hyperparameter groups may be reduced. Since all the tried parameter groups are expressed by the combinations of the base parameters and the difference parameters, ease of understanding the intention of the parameter setting increases for both the developer and the user.

(Hardware Configuration)

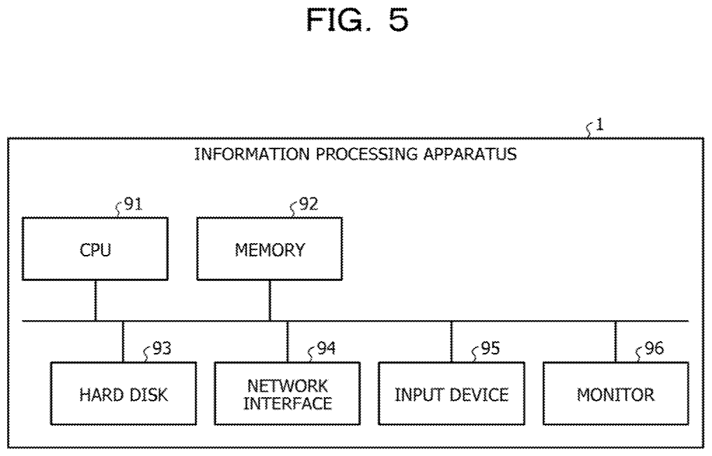

FIG. 5 is a hardware configuration diagram of the information processing apparatus. Next, an example of the hardware configuration for realizing the functions of the information processing apparatus 1 is described with reference to FIG. 5.

As illustrated in FIG. 5, the information processing apparatus 1 includes, for example, a central processing unit (CPU) 91, a memory 92, a hard disk 93, a network interface 94, and input device 95, and a monitor 96. The CPU 91 is coupled to the memory 92, the hard disk 93, and the network interface 94 via a bus.

Examples of the input device 95 include, for example, a keyboard, a mouse, and so forth. The input device 95 and the monitor 96 are included in the input/output device 12.

The network interface 94 is a communication interface between the information processing apparatus 1 and an external device. For example, the network interface 94 relays communication between the machine learning apparatus 2 and the CPU 91.

The hard disk 93 is an auxiliary storage device. The hard disk 93 realizes the function of the data storage unit 16 exemplified in FIG. 1. Also, the hard disk 93 stores various programs including programs for realizing the functions of the external file creation unit 11, part of the input/output device 12, the base obtaining unit 13, the difference obtaining unit 14, and the tried data management unit 15 exemplified in FIG. 1.

The memory 92 is a main storage device. As the memory 92, for example, a dynamic random-access memory (DRAM) may be used.

The CPU 91 reads the various programs from the hard disk 93, loads the programs onto the memory 92, and executes the programs. Thus, the CPU 91 realizes the functions of the external file creation unit 11, part of the input/output device 12, the base obtaining unit 13, the difference obtaining unit 14, and the tried data management unit 15 exemplified in FIG. 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a setting program for causing a computer to execute a process comprising:
accepting designation of a first setting value for an entirety of a plurality of hyperpara meters included in a machine learning model and designation of one or more second setting values that respectively indicate differences with respect to the first setting value; and
causing a plurality of hyperparameter groups generated based on the first setting value that has been designated and the second setting values that have been designated to be set in the machine learning model.

2. The non-transitory computer-readable recording medium according to claim 1, the process further comprising:
generating the plurality of hyperparameter groups by adding the differences indicated by the respective second setting values to the first setting value.

3. The non-transitory computer-readable recording medium according to claim 1, wherein,
regarding the second setting values, a plurality of groups of differences of different portions in the first setting value are set, and wherein
the process further including
accepting one or more of the second setting values in each of two or more of the groups; and
generating the plurality of hyperparameter groups by adding the differences indicated by the second setting values to the first setting value individually on a group-by-group basis.

4. The non-transitory computer-readable recording medium according to claim 1, the process further comprising:
storing, in a case where a machine learning process is tried by using the hyperparameter groups set in the machine learning model, in a storage device tried hyperpara meter groups that have been used in a trial; and,
upon reception of designation of the tried hyperparameter groups, obtaining the tried hyperparameter groups from the storage device and causing the obtained tried hyperparameter groups to be set in the machine learning model.

5. The non-transitory computer-readable recording medium according to claim 1, the process further comprising:
storing, in a case where a machine learning process is tried by using the hyperparameter groups set in the machine learning model, in a storage device tried hyperparameter information in which information on the first setting value used to generate tried hyperparameter groups used in a trial and the second setting values used to generate the tried hyperparameter groups used in the trial is registered; and,
upon reception of a request for displaying of the tried hyperpara meter information, obtaining the tried hyperparameter information from the storage device and causing the tried hyperparameter information to be displayed in a display device.

6. A method of setting comprising:
accepting designation of a first setting value for an entirety of a plurality of hyperpara meters included in a machine learning model and designation of one or more second setting values that respectively indicate differences with respect to the first setting value; and
causing a plurality of hyperparameter groups generated based on the first setting value that has been designated and the second setting values that have been designated to be set in the machine learning model.

7. An information processing apparatus comprising:
a memory; and
a processor coupled to the memory and configured to:
accept designation of a first setting value for an entirety of a plurality of hyperparameters included in a machine learning model and designation of one or more second setting values that respectively indicate differences with respect to the first setting value; and
cause a plurality of hyperparameter groups generated based on the first setting value that has been designated and the second setting values that have been designated to be set in the machine learning model.
